(19) United States
(12) Patent Application Publication
(10) Pub. No.: US 2006/0034645 A1
(43) Pub. Date: Feb. 16, 2006

(54) Magnetic roller sleeve for toner cartridge of printer

(75) Inventors: Cheng Lung Lee, Taipei Hsien (TW); Wen-Yi Wang, Cingshuei Township (TW)

Correspondence Address: DENNISON, SCHULTZ, DOUGHERTY & MACDONALD, 1727 KING STREET, SUITE 105, ALEXANDRIA, VA, 22314, US

(73) Assignee: PROWEAL COUNTER CORP.

(21) Appl. No.: 10/915,351

(22) Filed: Aug. 11, 2004

(51) Int. Cl. G03G 15/09

(52) U.S. Cl. 399/276

(57) ABSTRACT

A magnetic roller sleeve for toner cartridge of printer, wherein the cylinder surface of the sleeve is covered with a coating layer comprising: one or more resins highly adhesive to the sleeve base material, one or more electric conducting materials, a plurality of additive agents capable of evenly distributing electric conducting materials and resins and enhancing the bond between the two, and more than one additive agents and diluting solvents that can control the adhesive time during coating in separate stage; with the unique coating of the surface layer on the magnetic roller sleeve, the life cycle and print quality of the magnetic roller sleeve can be effectively enhanced.

### BACKGROUND OF THE INVENTION

1. Field of the invention

The present invention relates to a magnetic roller sleeve, and more particularly to a magnetic roller sleeve for toner cartridge of printer and business machine.

2. Description of the prior art

Accordingly, the image module of a laser printer, as shown in FIG. 1, includes: a photo-sensitive drum 11, which is a drum used to induct light and generate an electrostatic latent image on its surface; a corona bar 12, which is provided in one side of the surface of said photo-sensitive drum and used to distribute induction static electricity on the surface of said photo-sensitive drum; an exposure means 13, which is provided in another end away from said photo-sensitive drum and charging roller 12, and can receive the signal from an image reader to emit laser for exposure, so that an exposure area and non-exposure area similar to the image in the image reader are formed on the surface of photo-sensitive drum; a toner cartridge device 14, which is provided in another side of photo-sensitive drum in the backward position after exposure means is operated, used to provide storage of toner; a magnetic roller 15 with its surface covered by a developing sleeve, which is provided in front end of a toner cartridge outlet close to the photo-sensitive drum. The toners inside the cartridge device 14 are absorbed by magnetic force of the magnetic roller 15 and distributed on the outer surface of developing sleeve 16, after the developing sleeve 16 keeps rotating and has induction with the exposure area having static electricity on the surface of photo-sensitive drum 11, toners are then absorbed to the surface of photo-sensitive drum, and then, through the photo-sensitive drum 11, toners are brought to printing area. Afterwards, the toner transferring device 17 is used to transfer toners to adhere onto the surface of papers to form an image identical to the character or figure to be printed out. Then the image is obtained.

In the image developing means of printer described above, the quality of the magnetic roller sleeve has great effect on print quality.

Nevertheless, several problems of conventional magnetic roller sleeves (for example, the magnetic roller sleeves of U.S. Pat. Nos. 6,104,903, 6,178,306, 6,340,384, 6,341,420, 6,687,476 and 6,447,972) exist as described below:

1. When covered on the sleeve surface, owing to the external factors such as fluidity of coatings and gravity, the coating layer cannot be evenly distributed and thus the thickness of the coating layer varies. And, owing to the external factors such as oxygen and friction, the effect of thinner part of the coating layer decreases quickly and easily.

2. The coating layer cannot be distributed evenly on the sleeve surface, resulting in uneven distribution of the coating layer after drying, differing uneven and instable quality of the coating layer.

3. The coating layer on the sleeve surface can be peeled off owing to external slight rubs or crashes. This results in inferior print quality and short life cycle of the sleeve.

Accordingly, the present invention has been made for solving the above-mentioned problems occurred in the prior art.

### SUMMARY OF THE INVENTION

The object of present invention is to provide a magnetic roller sleeve of toner cartridge. In the magnetic roller sleeve for toner cartridge according to the present invention, the coating layer of the sleeve surface is coated by controlling the adhesion time of the coating layer in separate stage. Namely, the coatings can be evenly distributed on the sleeve surface without being effected by factors such as fluidity of the coatings and gravity. Therefore, the uniform thickness of the coating layer on the sleeve surface can be obtained.

Another object of the present invention is to provide a magnetic roller sleeve of toner cartridge according to the present invention. Since the coating layer of the sleeve has uniform thickness, the distribution of coatings after drying can be made evenly, thus the quality of the coating layer is uniform and stable.

A further object of the present invention is to provide a magnetic roller sleeve for toner cartridge, wherein the surface coatings have unique characteristic in smoothness that can effectively prevent the coating layer from warming out and makes the sleeve surface evenly flat, enhances print quality, and thus increases the life cycle of the sleeve.

The detailed structure, application principle, functions, and effect of the present invention will become more apparent by describing the preferred embodiment of the present invention with reference to the attached drawings.

### BRIEF DESCRIPTION OF THE DRAWINGS

FIG. 1 is a drawing showing the mechanism of the magnetic roller sleeve for printer's toiler cartridge.

FIG. 2 is a diagram showing the drying time and temperature elevation curves of the surface coatings according to the present invention.

FIG. 3 is a vertical sectional view of the magnetic roller sleeve according to the present invention.

FIG. 4 is a drawing showing the distribution of powder particle radius of electric conducting materials in the magnetic roller sleeve according to the present invention.

FIG. 5 is a chart comparing the surface roughness of the magnetic roller sleeve in the present invention and those available in the market.

FIGS. 6(a) and 6(b) are the charts comparing the print quality of the magnetic roller sleeve in the present invention and those available in the market.

FIGS. 7(a) and 7(b) are the other charts comparing the print quality of the magnetic roller sleeve in the present invention and those available in the market.

FIG. 8 is a chart comparing the printing density and printing sheets of the magnetic roller sleeve in the present invention and those available in the market.

### DETAILED DESCRIPTION OF THE PREFERRED EMBODIMENTS

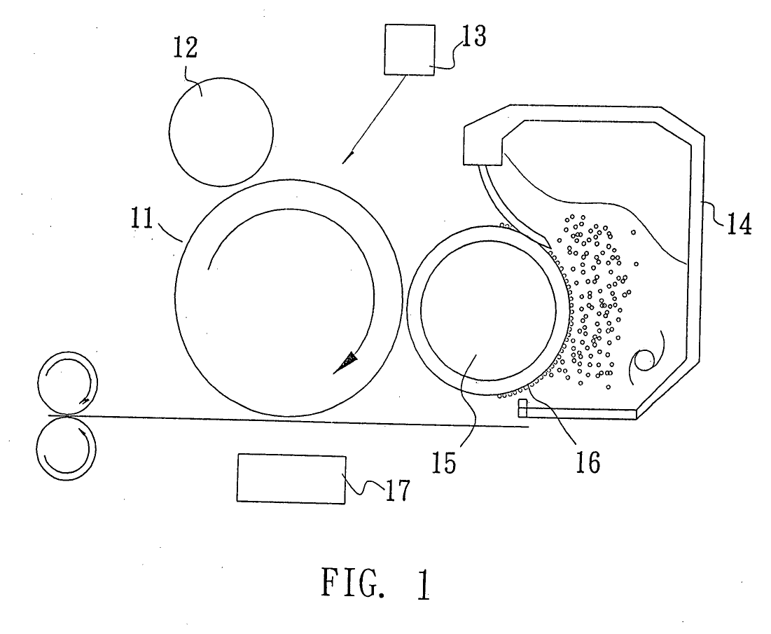

The deficiencies of the image developing means and magnetic roller sleeve of laser printer, as shown in FIG. 1, have been described in the previous section and will not be mentioned herewith.

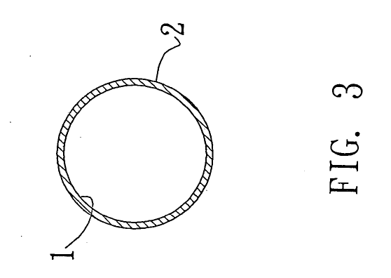

As shown in FIG. 3, the magnetic roller sleeve for toner cartridge according to the present invention is composed of a sleeve base material 1 and coating layer 2 covered thereon. The sleeve base material 1 adopts moldable metal as base material. For example, aluminum is a preferred base material.

The coating layer composition of the sleeve base material is composed of adhesive resins, electric conducting materials, diluting solvents, and additive agents. As concrete examples of the adhesive resin, thermosetting resins or thermoplastic resins are cited. Among them, examples of thermoplastic resins include unsaturated polyester, alkyd resins, and acrylic resins (copolymers); examples of thermosetting resins include amino resins, epoxy resins, polyurethane resins, phenolic resins, and etc; the preferred electric conducting materials can be carbon system electric conductive materials such as carbon black, carbon black fiber, graphite, graphite fiber; carbon nanotubes, etc.; metal system electric conductive materials such as metal powder and oxidization metal powders; ceramic system electric conductive materials such as electric conductive ceramics and Zirconium oxide or polymer system electric conductive materials such as electric conductive polymer, polyaniline, and polyacetylene. As concrete examples of the additive agents, polyurethane compounds dispersing agents, polyethylene wax dull agents, nonsilicone resin compounds improved paint adhesive agents (coupling agents), fluorocarbon modified polyacrylate slip and levelling agents, non-silicone polymeric compounds of defoaming agents, polyethylene wax precipitation prevention agents, acid polymer hardening agents, surface active agent compounds stabilizer, amine sault compound electric conducting agents, and etc. Diluting solvents can be aromatic compounds such as xylene and toluene; alcohols such as ethyl alcohol, iso propyl alcohol (IPA), methyl ethyl carbinol, and iso butyl alcohol (IBA); ketones such as acetone and methyl ethyl ketone; and esters such as ethyl acetate and Acetic acid ethyl glycolic esters.

In the coating compositions described above, the thermoplastic resins and thermosetting resins are present in an amount about 10-50 wt. %:5-30 wt. %. If resins are 100 wt. %, carbon system electric conducting materials are present in an amount from 10-85 wt. %; metal system electric conducting materials are from 1-10 wt. %; the remainder ceramic system electric conductive materials and polymer system electric conductive materials are from 1-5 wt. %. As regards the additive agents, if resins are 100 wt. %, dispersing agents are present in an amount from 1-10 wt. %; dull agents are from 5-25 wt. %; adhesive agents are from 0.01-2 wt. %; leveling agents are from 0.01-3 wt. %; deforming agents are from 0.01-4 wt. %; precipitation prevention agents are fiom 0.2-4 wt. %; hardening agents are from 0.5 to 10 wt. %; stabilizers are fiom 1-15 wt. %; and electric conducting agents are from 0.01-3 wt. %. As regards the diluting solvents, if resins are 100 wt. %, ketones are present in an amount from 6-35 wt. %; esters are from about 3-20 wt. %; aromatic compounds are from about 10-40 wt. %; alcohols are from about 6-35 wt. %.

In the coating compositions, thermoplastic resins are used to make coating compositions be adhered tightly with its high adhesiveness; thermosetting resins can enhance abrasion resistance; electric conducting materials are preferably 10⁻⁵-10² ohm and its particle radius is less than 9 μm. Additive agents are in the liquid or colloidal state, among which dispersing agents are used to make electric conducting materials evenly distributed without coagulation; dull agents are used to eliminate the luster of resins; adhesive agents are used to increase the adhesion of resins to base materials; leveling agents are used to make the coating compounds smooth with uniform thickness; defoaming agents are used to eliminate air bubbles resulted from the stirring during the process, thus a pinhole will not form on the coating layer owing to the breaking of air bubbles; precipitation prevention agents are used to prevent the precipitation of coating compositions, thus the effect of whole coating compounds being evenly distributed can be achieved; hardening agents are used to facilitate the hardening of resins; stabilizers are used to prevent coating compounds from reacting owing to external factors; electric conducting agents are used to further make the electric conducting effect of coating compounds not be affected by additive agents owing to the influence of electric conducting materials. Among the additive agents, dispersing agents, dull agents, adhesive agents, leveling agents, and defoaming agents are required and others are optional for use, depending on the condition. The diluting solvents are not only used to reduce the adhesiveness of the coating compositions, but retain the drying of the manufacture process when the coating compositions are layered on the base materials.

### EXAMPLES

(1) Fabrication of the Coatings

In fabricating the coating compositions according to the present invention, the process requires two times of stirring and the times of grind. When the first stirring is carried out, thermoplastic resins, thermosetting resins, electric conducting materials including carbon black, metal powders, and dispersing agents are mixed and diluted in an amount less than 40% and stirted with a mixing device at a temperature less than 40° C. (preferably 30 to 60 minutes); its stirring speed is 1000 to 12000 rpm and the pressure is less than 2 atm.

Moreover, before the first grinding is carried out, carbon nanotubes of the electric conducting materials, and, electric conducting agents and leveling agents of the additive agents are added and ground for 120-180 minutes; the grinder is preferably as continuous-distributed throughput machine. After the first grind is completed, additive agents, stabilizers and dull agents are added therein, and then the second grind is performed for 100 to 150 minutes. After the second grind is completed, defoaming agents, adhesive agents, and precipitation prevention agents are then added therein and then the third grind is performed for 60 to 120 minutes. The particle radius of the after-ground coating particle falls in the range of 0.1 to 30 μm, preferably in the range of 1 to 9 μm; the grind temperature is preferably controlled as 35±3° C. After the third grind, the second stilling procedure is carried out (preferably for 30 to 40 minutes), thereupon the hardening agents in the additive agents should be added and mixed with the remainder diluting solvents.

(2) Coating of Surface Layer

After the coating compositions according to the present invention are obtained, they can be layered on the sleeve base material by means of sputtering, electrostatic spraying and coating, soaking, and roller coating. The coating compositions can be layered for multiple times. The thickness of coatings layered each time falls in the range of 2 to 4 μm, and preferably, the thickness of the coating compositions falls in the range of 1.5 to 20 μm. The coating environment is controlled in a circumstance wherein the temperature is 25±3° C., humidity is 65+5% RH, and the number of dust particle is under 100,000.

(3) Drying of the Coating Layer

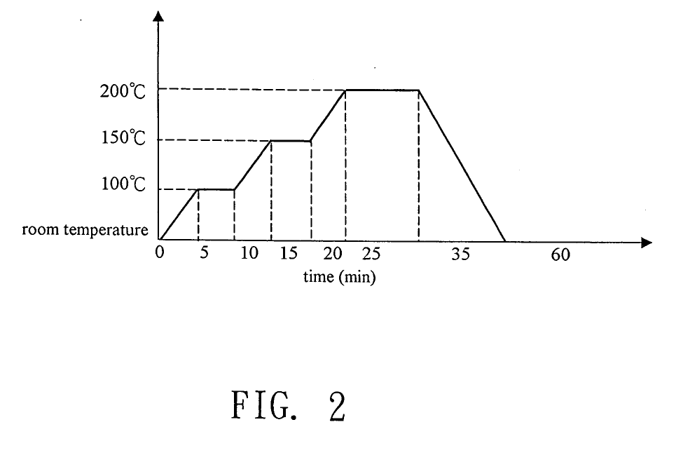

After the sleeve of the present invention is covered with coatings, it is then dried. The drying process may be separated as several stages wherein the drying time and drying temperature are showed as FIG. 2. Each stage is described respectively as follows:

A. Stage I (heating up from room temperature to 100° C.)

In this stage, the added ketone, alcohol, and ester type diluting solvents having the volatility and boiling point less than 100° C. react, making the cohesion of the coating particle to be maximum and adhered to the surface of sleeve base material in combination with the sleeve base material. Nevertheless, because the temperature is not so high, the coatings can maintain appropriate glidingly, having proper fluidity while they are dry. Thus the coating layer can be evenly distributed.

B. Stage II (100° C., thermostatic)

The diluting solvents reacted in the first stage are completely volatized, and thus the adhesion of coatings to the sleeve base material can be tightened.

C. Stage III (heating up from 100 to 150° C.)

In this stage, the added alcohol, and aromatic compounds diluting solvents having the volatility and boiling point less than 150° C. react, making the cohesion of the coating particle increased and tightly adhered to the surface of sleeve base material in better combination with the sleeve base material. However, because the temperature is not so high, the coatings can maintain appropriate glidingly, having proper fluidity while they are dry. Thus the coating layer can be evenly distributed.

D. Stage IV (150° C., thermostatic)

The diluting solvents reacted in third stage is completely volatilized, and thus the quality of coatings can be more solid.

E. Stage V (heating up from 150 to 200° C.)

In this stage, the added ester diluting solvents that have volatility points and boiling points less than 200° C. react while the additive agents react at the same time. In addition to the dispersing agents, leveling agents, and adhesive agents that have reacted in prior stages, the gross and air bubble of coatings have been removed.

F. Stage VI (200° C., thermostatic)

In this stage, the diluting solvents in the fifth stage are completely volatilized while the additive agents react at the same time.

G. Stage VII (cooling down from 200° C. to room temperature)

The added diluting solvents have been completely volatilized through stage 1 to 6 while the additive agents react as well. At this time, the coatings have been evenly distributed and combined, thus problems such as cracks or excessive roughness and improper adhesion of the coating layers due to rapid cooling can be avoided.

Through the seven drying stages, as shown in FIG. 3, a coating layer 2 is evenly formed on the surface of sleeve base material 1. In order to improve the smooth adhesion of the coatings, the levelling agents used in the coating layer are fluorocarbon modified polyacrylate of the polymer fluidextract having a prior dissolution and re-coating that can prevent the defects of the coatings such as concave, pinholes, and fish-eye, provide the coatings with the best fluidity and smoothness, and have dissolvable with aromatic compounds. Moreover, the diluting solvents that can control the adhesion time in separate stage during the coatings aim at providing the coatings and various addition materials with a buffer time for reaction and uniform coatings during the drying process by means of differing capability, volatility points, and boiling points. Moreover, the carbon nanotube having high conductivity can reduce the amount of other incorporated electric conducting materials while possess the same conductivity. Since the amount of other incorporated electric conducting materials decreases, the adhesion effect of the resins will not be reduced, thus superior adhesion of the coatings to the base material is obtained.

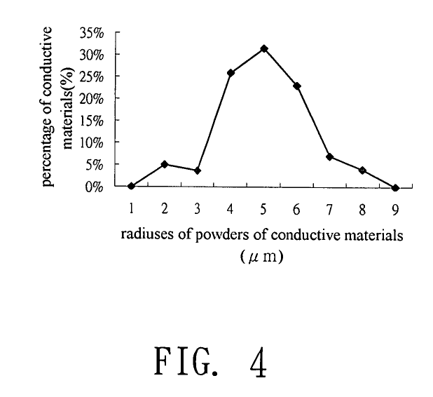

In particular, the electric conducting materials mixed with the coatings are solid powders whose particles radius are distributed as shown in FIG. 4. The particle radius preferably falls in the range of 1-9 μm. Those contain most electric conducting materials are the electric conducting powders whose particle radius is about 4, 5, or 6 μm.

### Comparative Examples

(1) Comparison of Surface Roughness

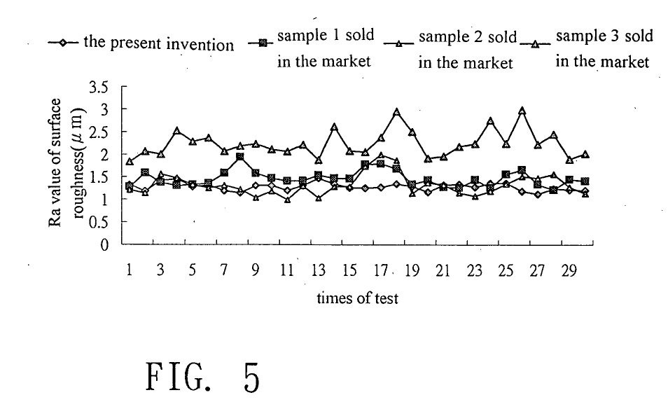

Three magnetic roller sleeves available in the market are tested several tiles in terms of surface roughness, and the results showed that the Ra value of currently available magnetic roller sleeves vary while the Ra value of magnetic roller sleeve in the present invention falls within a steady range (referring to FIG. 5).

(2) Comparison of Print Quality

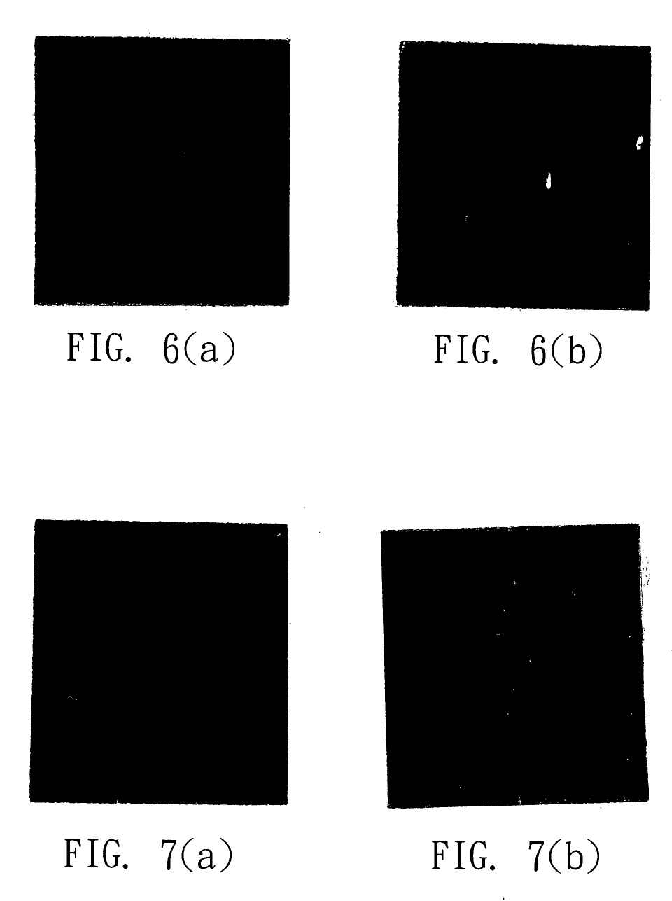

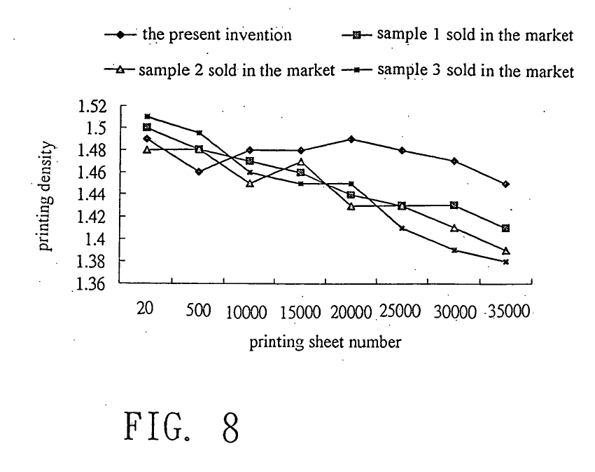

Referring to FIGS. 6 and 7, wherein the left drawings (a) illustrate the print quality of the magnetic roller sleeve of the present invention, after the conventional magnetic roller sleeve in a toner cartridge of printer was replaced by the magnetic roller sleeve of the present invention, while the right drawings (b) show the qualities of the printings of the magnetic roller sleeves before replaced.

(3) Comparison of Printing Density and Printing Sheet Number

Three magnetic roller sleeves currently available in the market were subjected to a printing test. The test results show that the magnetic roller sleeve of die present invention can maintain more stable print density than other magnetic roller sleeves after printing several ten thousands sheets.

As described above, the magnetic roller sleeve of toner cartridge according to the present invention certainly has superior coating uniformity, high-degree adhesiveness, high anti-abrasiveness, and proper coating surface roughness, which can improve the problem of short life cycle and poor print quality brought by conventional magnetic roller sleeve for toner cartridge. Also, the present invention has not yet opened to public, thus it is complied with the conditions of allowable patents.

Although the above-mentioned embodiments of the present invention has been described for illustrative purposes, those skilled in the ail will appreciate that various modifications, additions and substitutions are possible, without departing from the scope and spirit thereof as disclosed in the accompanying claims.

What is claimed is:

1. A magnetic roller sleeve for toner cartridge of printer, comprising: a sleeve body and the coating layer covered thereon, wherein the coating compositions include: adhesive resins such as thermosetting resins and thermoplastic resins, artificial or natural graphite, electric conducting materials such as electric conductive carbon black, metal powders, and carbon nanotubes, additive agents such as dispersing agents, dull agents, adhesive agents, and defoaming agents, and diluting solvents such as ketones, esters, alcohols, and aromatic compounds.

2. The magnetic roller sleeve for toner cartridge of printer as claimed in claim 1, wherein one or more precipitation prevention agents, hardening agents, stabilizers, and electric conductive agents are additionally added into additive agents.

3. The magnetic roller sleeve for toner cartridge of printer as claimed in claim 1, wherein ceramic system electric conductive materials and polymer system electric conductive materials are used as electric conducting materials.

4. The magnetic roller sleeve for toner cartridge of printer as claimed in claim 1, wherein thermoplastic resins are unsaturated polyesters, acrylic resins, or alkyd resins.

5. The magnetic roller sleeve for toner cartridge of printer as claimed in claim 1, wherein thermosetting resins are amino resins, phenolic resins, or epoxy resins.

6. The magnetic roller sleeve for toner cartridge of printer as claimed in claim 1, wherein the additive agents include: polyurethane compounds as dispersing agents; polyethylene wax as dull agents; nonsilicone resin compounds as paint improved adhesive agents; fluorocarbon modified polyacrylate as slip and levelling agents; non-silicone polymeric compounds of defoaming agents.

7. The magnetic roller sleeve for toner cartridge of printer as claimed in claim 2, wherein the precipitation prevention agents are polyethylene waxes, the hardening agents are acidic polymers, the stabilizers are surface active agent compounds, the electric conducting agents are amine sault compounds.

8. The magnetic roller sleeve for toner cartridge of printer as claimed in claim 1, wherein ketones diluting solvents are the mixture of acetone or methyl ethyl ketone, or both.

9. The magnetic roller sleeve for toner cartridge of printer as claimed in claim 1, wherein esters diluting solvents are the mixture of ethyl acetate or Acetic acid ethyl glycolic esters or both.

10. The magnetic roller sleeve for toner cartridge of printer as claimed in claim 1, wherein alcohol diluting solvents are the mixture of ethyl alcohol, butyl alcohol, iso propyl alcohol (IPA), or iso butyl alcohol (IBA), or both.

11. The magnetic roller sleeve for toner cartridge of printer as claimed in claim 1, wherein aromatic compounds diluting solvents are xylene or toluene.
